(19) United States
(12) Patent Application Publication
(10) Pub. No.: US 2020/0249450 A1
(43) Pub. Date: Aug. 6, 2020

(54) PROJECTION OPTICAL DEVICE AND PROJECTOR

(71) Applicant: SEIKO EPSON CORPORATION, Tokyo (JP)

(72) Inventors: Hirofumi OKUBO, Matsumoto-shi (JP); Koji SHIOKAWA, Azumino-shi (JP)

(73) Assignee: SEIKO EPSON CORPORATION, Tokyo (JP)

(21) Appl. No.: 16/782,176

(22) Filed: Feb. 5, 2020

(30) Foreign Application Priority Data
Feb. 6, 2019 (JP) 2019-019520

(51) Int. Cl. G02B 15/177; G02B 13/16; H04N 9/31; G03B 21/28; G02B 13/00

(52) U.S. Cl. CPC G02B 15/177; G02B 13/16; G02B 13/0065; G03B 21/28; H04N 9/3197; H04N 9/3152

(57) ABSTRACT

A projection optical device includes a first lens group with a plurality of lenses arranged on a first optical axis, and which light emitted from a reduction side conjugate plane enters, a first reflecting element configured to reflect the light emitted from the first lens group to fold an optical path, a second lens group with a plurality of lenses arranged on a second optical axis, and which the light emitted from the first reflecting element enters, a second reflecting element configured to reflect the light emitted from the second lens group to fold an optical path, and a third lens group with a plurality of lenses arranged on a third optical axis, and which transmits the light emitted from the second reflecting element to emit the light toward an enlargement side conjugate plane, wherein defining an angle formed between the first and second optical axis as α[°], α≠90°.

The present application is based on, and claims priority from JP Application Serial Number 2019-019520, filed Feb. 6, 2019, the disclosure of which is hereby incorporated by reference herein in its entirety.

### BACKGROUND

### 1. Technical Field

The present disclosure relates to a projection optical device and a projector.

### 2. Related Art

In the field of projectors, there is used a large-size projection lens unit having a number of lenses with the purpose of an improvement in display quality, an increase in degree of freedom of an installation environment, and so on. In particular, in a projection lens unit compatible with short focal length, there is a tendency that the total length of the projection lens unit elongates and the weight thereof increases due to a factor such as ensuring an optical path length of an enlargement side optical system, or an increase in lens diameter. Thus, there have arisen problems such as an increase in occupied space by the projector and a difficulty in stably supporting the projection lens unit. In order to solve these problems, there is provided a flexion type projection lens unit having a configuration of folding an optical path inside the unit.

In JP-A-2016-156986 (Document 1), there is disclosed a “projecting optical system” provided with a first optical system constituted by a plurality of lenses, a first optical path folding device for folding the optical path with a reflecting surface, and a second optical system including a first lens group, a second optical path folding device, and a second lens group.

In Document 1, there is a description that the first optical path folding device and the second optical path folding device are each disposed in a posture of folding the optical path as much as 90°. However, when applying the projecting optical system in Document 1 to a projector, there is a problem that the occupied space by the constituent member becomes large in the vicinity of a support section of the projecting optical system to a main body part of the projector. Further, when attempting to elongate the optical length of the second optical system, it is inevitable to elongate the distance between the first optical path folding device and the second optical path folding device, and thus, the whole of the projector grows in size.

### SUMMARY

A projection optical device according to an aspect of the present disclosure is a projection optical device configured to project a display image on a reduction side conjugate plane onto an enlargement side conjugate plane to generate a projection image, the projection optical device including a first lens group which has a plurality of lenses arranged on a first optical axis, and which light emitted from the reduction side conjugate plane enters, a first reflecting element configured to reflect the light emitted from the first lens group to fold an optical path, a second lens group which has a plurality of lenses arranged on a second optical axis, and which the light emitted from the first reflecting element enters, a second reflecting element configured to reflect the light emitted from the second lens group to fold an optical path, and a third lens group which has a plurality of lenses arranged on a third optical axis, and which transmits the light emitted from the second reflecting element to emit the light toward the enlargement side conjugate plane, wherein α≠90° where an angle formed between the first optical axis and the second optical axis is α[°].

The projection optical device according to the aspect of the present disclosure may be configured such that β=180°−α where an angle formed between the second optical axis and the third optical axis is β[°], and a posture of the projection image may be flipped 180° with respect to a posture of the display image.

The projection optical device according to the aspect of the present disclosure may be configured such that 95°≤α≤110°.

In the projection optical device according to the aspect of the present disclosure, among the plurality of lenses constituting the third lens group, an enlargement side lens located at a nearest position to the enlargement side conjugate plane may have an asymmetric shape with respect to the third optical axis, and a first portion located on a nearer side to the first lens group with respect to the third optical axis of the enlargement side lens may have a shape of a second portion located on a farther side from the first lens group with respect to the third optical axis with a missing part.

In the projection optical device according to the aspect of the present disclosure, an intermediate image of the display image may be formed at a position conjugate with the reduction side conjugate plane, and the intermediate image may be projected on the enlargement side conjugate plane.

A projector according to another aspect of the present disclosure includes a light source device configured to emit light, a light modulation device configured to modulate light emitted from the light source device in accordance with image information, and a projection optical device according to any one of the above aspects of the present disclosure configured to project the light modulated by the light modulation device on a projection target surface.

### BRIEF DESCRIPTION OF THE DRAWINGS

FIG. 1 is a schematic configuration diagram of a projector according to an embodiment of the present disclosure.

FIG. 2 is a perspective view of a projection optical device.

FIG. 3 is a schematic configuration diagram of the projection optical device.

FIG. 4 is a front view and a cross-sectional view of an enlargement side lens.

### DESCRIPTION OF AN EXEMPLARY EMBODIMENT

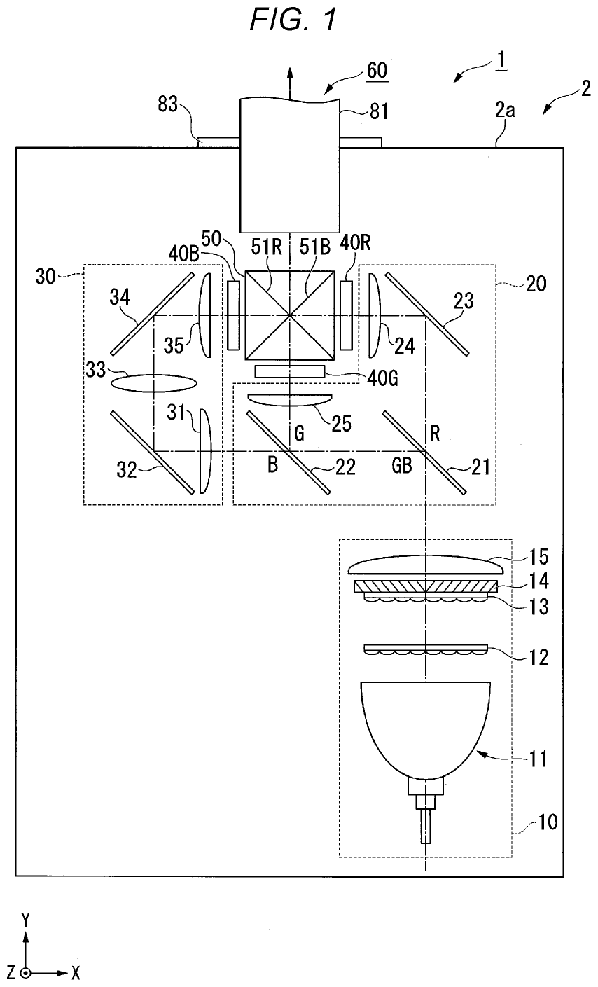

Hereinafter, an embodiment of the present disclosure will be described using FIG. 1 through FIG. 3.

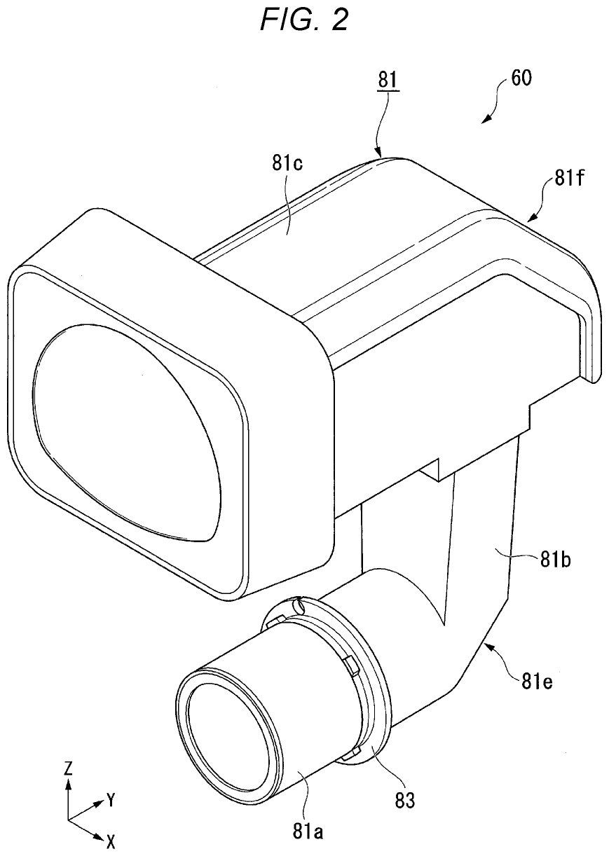

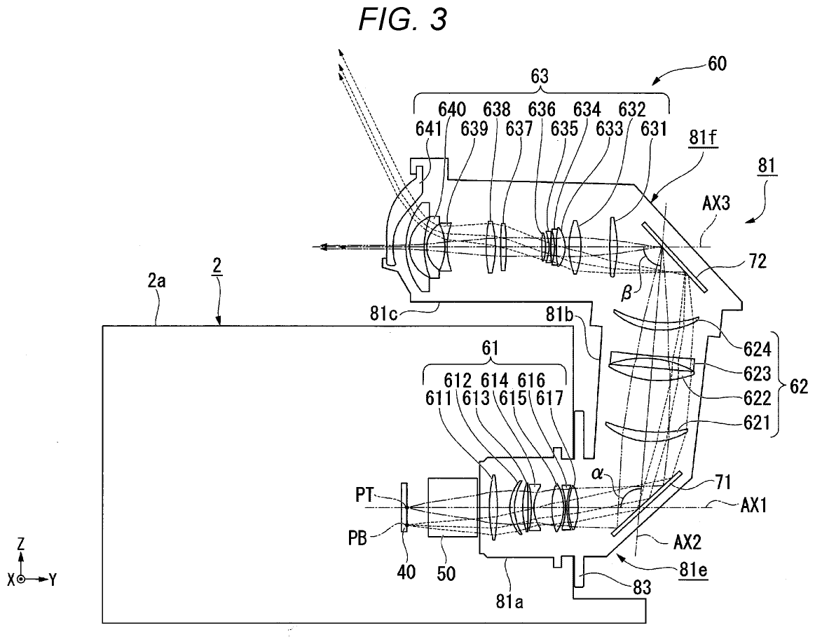

FIG. 1 is a schematic configuration diagram of a projector according to the present embodiment. FIG. 2 is a perspective view of a projection optical device provided to the projector according to the present embodiment. FIG. 3 is a schematic configuration diagram of the projection optical device.

It should be noted that in each of the drawings described below, the constituents are shown with the scale ratios of respective sizes set differently between the constituents in some cases in order to facilitate the visualization of each of the constituents.

In each of the drawings described below, an X axis, a Y axis, and a Z axis as coordinate axes perpendicular to each other are attached as needed. On this occasion, the X axis, the Y axis, and the Z axis in each of the drawings are set so that the X-Y plane substantially coincides with a horizontal plane, and the Z-axis direction corresponds to a vertical direction. The projector according to the present embodiment is assumed to be installed on a desk, the floor, or the like in the posture shown in FIG. 3, and a positive direction pointed by the arrow of the Z axis is referred to as an “upper side,” and a negative direction is referred to as a “lower side” in some cases for the sake of convenience of explanation. It should be noted that it is also possible to vertically flip the posture of the projector shown in FIG. 3 to install the projector on the ceiling.

An example of a projector according to the present embodiment will be described.

The projector according to the present embodiment is a projection-type image display device for displaying a full-color image on a screen (a projection target surface). The projector is provided with three light modulation devices formed of liquid crystal light valves for respectively modulating colored light, namely red light, green light, and blue light.

As shown in FIG. 1, the projector 1 according to the present embodiment is provided with a main body part 2, an exterior housing 2a, and a projection lens unit 60 (a projection optical device). The main body part 2 is housed in the exterior housing 2a. The exterior housing 2a is formed of, for example, a resin material, and has a configuration having a plurality of members combined with each other.

The projection lens unit 60 is disposed so as to project from the exterior housing 2a. The projection lens unit 60 is detachably attached to the main body part 2 via a flange part 83. The projection lens unit 60 in the present embodiment is a projection lens unit compatible with super-short focal length, and is made replaceable with a standard lens unit and so on. In the state in which the projection lens unit 60 is attached, it is possible to install the projector 1 at a position close to the screen to project an image. It should be noted that the projection lens unit 60 is not necessarily required to be configured so as to detachably be attached to the main body part 2. The detailed configuration of the projection lens unit 60 will be described later.

The main body part 2 is provided with a light source device 10 as an illumination optical system, a color separation optical system 20, a relay optical system 30, three liquid crystal light valves 40R, 40G, and 40B as the light modulation devices, and a cross dichroic prism 50 as a color combining optical system. The liquid crystal light valves 40R, 40G, and 40B each modulate the light emitted from the light source device 10 in accordance with image information. The projection lens unit 60 projects the light modulated by the liquid crystal light valves 40R, 40G, and 40B on the projection target surface.

The light source device 10 is provided with a light source 11, a first lens array 12, a second lens array 13, a polarization conversion element 14, and a superimposing lens 15. The first lens array 12 and the second lens array 13 each have a configuration having a plurality of microlenses arranged in a matrix in the X-Z plane.

Although in the projector 1 according to the present embodiment, a lamp is adopted as the light source 11, the type of the light source 11 is not limited to the lamp. As the light source 11, there can be adopted a solid-state light source such as a light emitting diode or a laser, or there can also be adopted a light source device including a wavelength conversion element having a phosphor generating fluorescence due to irradiation with excitation light.

The light emitted from the light source 11 is divided by the first lens array 12 into a plurality of partial light beams. The plurality of partial light beams is superimposed by the second lens array 13 and the superimposing lens 15 in effective display areas of the three liquid crystal light valves 40R, 40G, and 40B as an illumination target. In other words, the first lens array 12, the second lens array 13, and the superimposing lens 15 constitute an integrator optical system for illuminating the liquid crystal light valves 40R, 40G, and 40B with a substantially homogenous illuminance distribution using the light emitted from the light source 11.

The polarization conversion element 14 uniforms unpolarized light emitted from the light source 11 into linearly polarized light available in the three liquid crystal light valves 40R, 40G, and 40B.

The color separation optical system 20 is provided with a first dichroic mirror 21, a second dichroic mirror 22, a reflecting mirror 23, a field lens 24, and a field lens 25. The color separation optical system 20 separates the light emitted from the light source device 10 into three colors of colored light having respective wavelength bands different from each other. The three colors of colored light are red light R, green light G, and blue light B. The field lens 24 is disposed on a light incidence side of the liquid crystal light valve 40R. The field lens 25 is disposed on a light incidence side of the liquid crystal light valve 40G.

The first dichroic mirror 21 transmits the red light R, and at the same time reflects the green light G and the blue light B. The red light R transmitted through the first dichroic mirror 21 is reflected by the reflecting mirror 23, and then transmitted through the field lens 24 to illuminate the liquid crystal light valve 40R for the red light.

The field lens 24 collects the light reflected by the reflecting mirror 23 to illuminate the liquid crystal light valve 40R. Similarly to the field lens 24, the field lens 25 collects the light reflected by the reflecting mirror 22 to illuminate the liquid crystal light valve 40G. The light illuminating the liquid crystal light valve 40R is converted by the field lens 24 into a substantially parallel light beam, and the light illuminating the liquid crystal light valve 40G is converted by the field lens 25 into a substantially parallel light beam.

The second dichroic mirror 22 transmits the blue light B, and at the same time reflects the green light G. The green light G reflected by the first dichroic mirror 21 is reflected by the second dichroic mirror 22, and then transmitted through the field lens 25 to illuminate the liquid crystal light valve 40G for the green light.

The first dichroic mirror 21 and the second dichroic mirror 22 are each manufactured by forming a dielectric multilayer film corresponding to the reflecting/transmitting characteristics required for the respective dichroic mirror on a transparent glass plate.

The relay optical system 30 is provided with an incidence side lens 31, a first reflecting mirror 32, a relay lens 33, a second reflecting mirror 34, and an exit side lens 35 as a field lens. The blue light B is longer in optical path than the red light R and the green light G, and is therefore apt to increase in light loss. Therefore, by using the relay lens 33, the light loss is suppressed. The blue light B emitted from the color separation optical system 20 is reflected by the first reflecting mirror 32, and at the same time converged by the incidence side lens 31 on the vicinity of the relay lens 33. Subsequently, the blue light B is diffused toward the second reflecting mirror 34 and the exit side lens 35.

The exit side lens 35 has substantially the same function as those of the field lenses 24, 25 described above, and illuminates the liquid crystal light valve 40B. The light illuminating the liquid crystal light valve 40B is converted by the exit side lens 35 into a substantially parallel light beam.

The liquid crystal light valves 40R, 40G, and 40B for the respective colored light each convert the incident colored light into light with the intensity corresponding to an image signal corresponding to the colored light, and then emit the result as modulated light. As the liquid crystal light valves 40R, 40G, and 40B, there are adopted transmissive liquid crystal panels (not shown). Further, on the light incidence side and the light exit side of each of the liquid crystal panels, there are respectively disposed polarization plates (not shown).

It should be noted that the liquid crystal light valves 40R, 40G, and 40B as the light modulation devices are not limited to the configuration including the transmissive liquid crystal panel. It is also possible to adopt a reflective type light modulation device such as reflective liquid crystal panel as the light modulation device. Further, it is also possible to use a digital micromirror device or the like for modulating the light emitted from the light source 11 by controlling the emission direction of the incident light for each of the micromirrors as pixels. Further, the configuration of providing the light modulation devices respectively for the plurality of colored light is not a limitation, but it is also possible to adopt a configuration of modulating the plurality of colored light with a single light modulation device in a time-sharing manner.

The cross dichroic prism 50 combines the modulated light of the respective colors emitted from the liquid crystal light valves 40R, 40G, and 40B with each other. The cross dichroic prism 50 has a red light reflecting dichroic mirror 51R for reflecting the red light R and transmitting the blue light B and the green light G, and a blue light reflecting dichroic mirror 51B for reflecting the blue light B and transmitting the red light R and the green light G. The red light reflecting dichroic mirror 51R is formed of a dielectric multilayer film for reflecting the red light R and transmitting the green light G. The blue light reflecting dichroic mirror 51B is formed of a dielectric multilayer film for reflecting the blue light B and transmitting the green light G. Hereinafter, the red light reflecting dichroic mirror 51R and the blue light reflecting dichroic mirror 51B are simply referred to as dichroic mirrors 51R, 51B in some cases.

The dielectric multilayer film for reflecting the red light R and transmitting the green light G, and the dielectric multilayer film for reflecting the blue light B and transmitting the green light G are arranged to form a substantially X shape in a plan view viewed from the Z-axis direction. The three colors of modulated light of the red light R, the green light G, and the blue light B are combined with each other by the dichroic mirrors 51R, 51B to form composite light for displaying the color image. The composite light generated by the cross dichroic prism 50 is emitted toward the projection lens unit 60.

The composite light emitted from the main body part 2 is projected on the projection target surface such as the screen not shown via the projection lens unit 60.

The projection lens unit 60 will hereinafter be described.

The display image on the reduction side conjugate plane is projected by the projection lens unit 60 on the enlargement side conjugate plane, and thus the projection image is generated. In the case of the present embodiment, the reduction side conjugate plane corresponds to a display surface of each of the liquid crystal light valves 40R, 40G, and 40B. Further, the enlargement side conjugate plane corresponds to the projection target surface such as the screen. The projection lens unit 60 forms an intermediate image of the display image at a position conjugate with the reduction side conjugate plane, and projects the intermediate image on the enlargement side conjugate plane.

As shown in FIG. 2 and FIG. 3, the projection lens unit 60 is provided with a first lens group 61, a first mirror (a first reflecting element), a second lens group 62, a second mirror 72 (a second reflecting element), a third lens group 63, a lens unit housing 81, and a flange part 83. The first lens group 61 and the second lens group 62 function as the reduction side optical system. The third lens group 63 functions as the enlargement side optical system.

The lens unit housing 81 has a first flexion part 81e and a second flexion part 81f. Thus, since the optical path of the image light is folded twice inside the projection lens unit 60, the projection lens unit 60 emits the image light in an opposite direction to the direction in which the light is emitted from the main body part 2.

The first lens group 61 has a plurality of lenses 611 through 617 arranged on a first optical axis AX1, and the light emitted from the reduction side conjugate plane enters the first lens group 61. In the case of the present embodiment, the first lens group 61 has the seven lenses, namely the lenses 611 through 617. The lenses 611 through 617 are arranged so that all of the optical axes of the respective lenses 611 through 617 are located on the first optical axis AX1. The lenses 611 through 617 include a variety of shapes of lenses such as a convex lens or a concave lens. The number, the shapes, the sizes, and the arrangement of the lenses 611 through 617 are not particularly limited.

The first mirror 71 reflects the image light emitted from the first lens group 61 to fold the optical path.

The second lens group 62 has a plurality of lenses 621 through 624 arranged on a second optical axis AX2, and the image light emitted from the first mirror 71 enters the second lens group 62. In the case of the present embodiment, the second lens group 62 has the four lenses, namely the lenses 621 through 624. The lenses 621 through 624 are arranged so that all of the optical axes of the respective lenses 621 through 624 are located on the second optical axis AX2. The lenses 621 through 624 include a variety of shapes of lenses such as a convex lens or a concave lens. The number, the shapes, the sizes, and the arrangement of the lenses 621 through 624 are not particularly limited.

The second mirror 72 reflects the image light emitted from the second lens group 62 to fold the optical path.

The third lens group 63 has a plurality of lenses 631 through 641 arranged on a third optical axis AX3, and transmits the image light emitted from the second mirror 72 to emit the image light toward the enlargement side conjugate plane. In the case of the present embodiment, the third lens group 63 has the eleven lenses, namely the lenses 631 through 641. The lenses 631 through 641 are arranged so that all of the optical axes of the respective lenses 631 through 641 are located on the third optical axis AX3. The lenses 631 through 641 include a variety of shapes of lenses such as a convex lens or a concave lens. The number, the shapes, the sizes, and the arrangement of the lenses 631 through 641 are not particularly limited.

The first optical axis AX1 of the first lens group 61 and the second optical axis AX2 of the second lens group 62 cross each other at an angle other than the right angle. In other words, defining the angle formed between the first optical axis AX1 and the second optical axis AX2 as α[°], α≠90° is fulfilled. In the case of the present embodiment, a is an obtuse angle, and α=95°, for example, is assumed. On this occasion, the first mirror 71 is installed at an angle at which the incident angle of the image light emitted from the first lens group 61 with respect to the first mirror 71 is 47.5°.

Further, the second optical axis AX2 of the second lens group 62 and the third optical axis AX3 of the third lens group 63 cross each other at an angle other than the right angle. In other words, defining the angle formed between the second optical axis AX2 and the third optical axis AX3 as β[°], β≠900 is fulfilled. Further, the first optical axis AX1 and the third optical axis AX3 are both parallel to the Y axis, and are therefore parallel to each other. In other words, β=180°−α is fulfilled. In the case of the present embodiment, β is an acute angle, and β=85°, for example, is assumed. On this occasion, the second mirror 72 is installed at an angle at which the incident angle of the image light emitted from the second lens group 62 with respect to the second mirror 72 is 42.5°.

In FIG. 3, there are shown the optical path of the image light emitted from an upper end PT of the display image located on the first optical axis AX1, namely the optical path represented by the dashed-two-dotted line, and the optical path of the image light emitted from a lower end PB of the display image, namely the optical path represented by the dotted line out of the display image on the liquid crystal light valve 40. As shown in FIG. 3, the image light emitted from the upper end PT of the display image enters a lower part of the screen to form a lower end of the projection image. In contrast, the light emitted from the lower end PB of the display image enters an upper part of the screen to form an upper end of the projection image. In such a manner, the posture of the projection image is flipped 180° with respect to the posture of the display image.

The lens 641 located at the nearest position to the enlargement side conjugate plane out of the plurality of lenses 631 through 641 constituting the third lens group 63 is hereinafter referred to as an enlargement side lens 641.

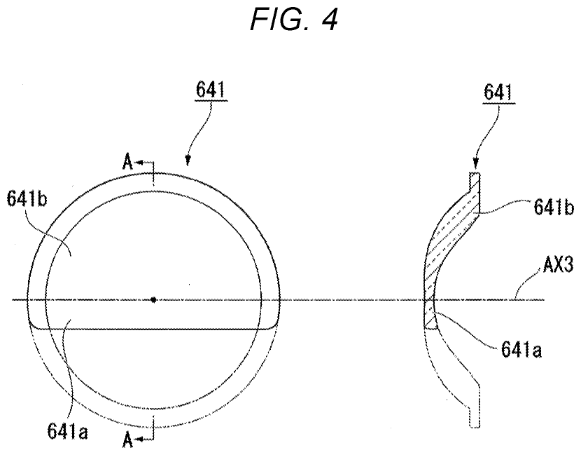

FIG. 4 is a front view and a cross-sectional view of the enlargement side lens 641, wherein the left part of FIG. 4 corresponds to the front view, and the right part of FIG. 4 corresponds to the cross-sectional view along the line A-A in the front view located on the left side.

As shown in FIG. 4, the enlargement side lens 641 has an asymmetric shape with respect to the third optical axis AX3. Here, a portion located below the third optical axis AX3, namely located on a nearer side to the first lens group 61, of the enlargement side lens 641 is defined as a first portion 641a, and a portion located above the third optical axis AX3, namely located on the farther side from the first lens group 61, of the enlargement side lens 641 is defined as a second portion 641b. When viewing the enlargement side lens 641 from a direction along the third optical axis AX3, the shape of the second portion 641b is a sector shape with the central angle of 180°, and the shape of the first portion 641a is a shape obtained by cutting off a lower part of the sector shape with the central angle of 180°. As described above, the first portion 641a has the shape of the second portion 641b with a missing part.

The lens unit housing 81 is formed of a cylindrical member having the two flexion parts consisting of the first flexion part 81e and the second flexion part 81f. The lens unit housing 81 houses the first lens group 61, the first mirror 71, the second lens group 62, the second mirror 72, and the third lens group 63. In the lens unit housing 81, a portion housing the first lens group 61 is referred to as a first cylinder part 81a, a portion housing the second lens group 62 is referred to as a second cylinder part 81b, and a portion housing the third lens group 63 is referred to as a third cylinder part 81c. Although not shown in the drawings, inside the lens unit housing 81, there is disposed a support section for supporting the individual lenses constituting the first lens group 61, the second lens group 62, and the third lens group 63, the first mirror 71, and the second mirror 72. The constituent material, the shape, the size, and so on of the lens unit housing 81 are not particularly limited.

As shown in FIG. 1, the flange part 83 located between the lens unit housing 81 and the main body part 2 to fix the projection lens unit 60 to the main body part 2. The flange part 83 is attached to the exterior housing 2a of the main body part 2 with a fixation measure such as a screw. Therefore, positioning between the main body part 2 and the projection lens unit 60 is achieved in the state in which the projection lens unit 60 is mounted on the main body part 2. It should be noted that it is also possible to arrange that the relative positional relationship between the main body part 2 and the projection lens unit 60 can be adjusted by a positioning mechanism.

When using a related-art projection lens unit in which the first optical axis and the second optical axis crossing at a right angle, it is necessary to take a relatively long distance from the flange part to the first mirror on the grounds that the lens unit housing and the exterior housing physically interfere with each other, and there is a problem that it is difficult to achieve reduction in size of the periphery of the flange part.

To cope with this problem, in the projection lens unit 60 according to the present embodiment, since the angle α formed between the first optical axis AX1 and the second optical axis AX2 is an obtuse angle, the end part on the second flexion part 81f side of the second cylinder part 81b is displaced toward the direction of getting away from the exterior housing 2a compared to the related-art projection lens unit, and the lens unit housing 81 and the exterior housing 2a become difficult to physically interfere with each other. Therefore, according to the projection lens unit 60 related to the present embodiment, since it is possible to make the position of the first mirror 71, namely the position of the first flexion part 81e, nearer to the main body part 2 compared to the related-art projection lens unit, it is possible to achieve reduction in size and reduction is space of the periphery of the flange part 83.

Further, even when the distance from the lens 611 to the first mirror 71 shortens, in order to ensure a predetermined optical performance, it is necessary to elongate the optical path of the second lens group 62 disposed between the first mirror 71 and the second mirror 72. However, in the related-art projection lens unit, when elongating the optical path length of the second lens group, the distance between the first optical axis AX1 and the third optical axis AX3 increases, and there is a problem that the total height of the projector increases.

To cope with this problem, in the projection lens unit 60 according to the present embodiment, since the angle α formed between the first optical axis AX1 and the second optical axis Ax2 is the obtuse angle, the second optical axis AX2 is tilted with respect to a direction perpendicular to the first optical axis AX1, and accordingly, it is possible to elongate the optical path length of the second lens group 62 without increasing the distance between the first optical axis AX1 and the third optical axis AX3. Therefore, according to the projection lens unit 60 related to the present embodiment, it is possible to maintain the desired optical performance without increasing the total height of the projector 1.

It is desirable for the angle α formed between the first optical axis AX1 and the second optical axis AX2 to be in a range of 95°≤α≤110°. The reason it that when the angle α is smaller than 95°, the advantage of the reduction in size of the periphery of the flange part 83 can hardly be obtained, and when the angle α exceeds 110°, the centroid of the projection lens unit 60 gets away too much from the main body part 2 to increase the load on the flange part 83, and at the same time, the total length of the projector 1 increases.

In the projection lens unit 60 according to the present embodiment, there is no problem when emitting the image light obliquely upward at a large emission angle from the enlargement side lens 641 as shown in FIG. 3, but if the light is emitted obliquely downward at a large emission angle from the enlargement side lens 641, vignetting of the image light is caused by the exterior housing 2a, and the correct projection image cannot be obtained. Therefore, in order to emit the image light on the lower end side of the projection image substantially along the third optical axis AX3, there is adopted the configuration of making the image light enter the upper part side of the enlargement side lens 641. In such a circumstance, in the present embodiment, since the first portion 641a of the enlargement side lens 641 has the shape of the second portion 641b with a missing part, it is possible to achieve the reduction in size of the projection lens unit 60, and it is possible to prevent the total height of the projector 1 from increasing.

It should be noted that the scope of the present disclosure is not limited to the embodiments described above, but a variety of modifications can be provided thereto within the scope or the spirit of the present disclosure.

For example, although in the embodiment described above, the angle α formed between the first optical axis AX1 and the second optical axis AX2 is set to the obtuse angle, the angle θ formed between the second optical axis AX2 and the third optical axis AX3 is set to the acute angle, and α+β=180° is assumed, it is possible to set the angle α to an acute angle, the angle θ to an obtuse angle, and to assume α+β=180° in an opposite manner to this example. According to this configuration, in addition to the fact that there can be obtained the advantage that the optical path length of the second lens group can be obtained similarly to the embodiment described above, the elongation side lens can be disposed at a position nearer to the front side (the −Y side in FIG. 3) of the main body part.

Alternatively, it is possible to set the angle α to α≠90°, the angle β to β=90°, and to assume α+β≠180° instead of the embodiment described above. Even in this case, substantially the same advantages as described above can be obtained.

Further, although in the embodiment described above, the mirrors are used as the first reflecting element and the second reflecting element, it is also possible to use, for example, prisms instead of the mirrors. It should be noted that from the view point that the light loss is small, reduction in weight of the projection lens unit can be achieved, and so on, it is desirable to use the mirrors as the first reflecting element and the second reflecting element.

Besides the above, the specific descriptions of the shapes, the number, the arrangement, the materials, and so on of the constituents of the projection lens unit and the projector are not limited to those of the embodiment described above, but can arbitrarily be modified. It is also possible for the projection lens unit to include other functions such as a lens shift function. Further, although in the above embodiment, there is described the example of installing the projection lens unit according to the present disclosure in the projector using the liquid crystal light valves, the example is not a limitation. For example, it is also possible to implement the projection lens unit according to the present disclosure in the projector using digital micromirror devices as the light modulation devices.

What is claimed is:

1. A projection optical device configured to project a display image on a reduction side conjugate plane onto an enlargement side conjugate plane to generate a projection image, the projection optical device comprising:
a first lens group which has a plurality of lenses arranged on a first optical axis, and which light emitted from the reduction side conjugate plane enters;
a first reflecting element configured to reflect the light emitted from the first lens group to fold an optical path;
a second lens group which has a plurality of lenses arranged on a second optical axis, and which the light emitted from the first reflecting element enters;
a second reflecting element configured to reflect the light emitted from the second lens group to fold an optical path; and
a third lens group which has a plurality of lenses arranged on a third optical axis, and which transmits the light emitted from the second reflecting element to emit the light toward the enlargement side conjugate plane, wherein
α≠90°, where an angle formed between the first optical axis and the second optical axis is α[°].

2. The projection optical device according to claim 1, wherein
β=180°−α where an angle formed between the second optical axis and the third optical axis is β[°], and
a posture of the projection image is flipped 180° with respect to a posture of the display image.

3. The projection optical device according to claim 1, wherein
95°≤α≤110°.

4. The projection optical device according to claim 2, wherein
among the plurality of lenses constituting the third lens group, an enlargement side lens located at a nearest position to the enlargement side conjugate plane has an asymmetric shape with respect to the third optical axis, and
a first portion located on a nearer side to the first lens group with respect to the third optical axis of the enlargement side lens has a shape of a second portion located on a farther side from the first lens group with respect to the third optical axis with a missing part.

5. The projection optical device according to claim 1, wherein
an intermediate image of the display image is formed at a position conjugate with the reduction side conjugate plane, and the intermediate image is projected on the enlargement side conjugate plane.

6. A projector comprising:
a light source device configured to emit light;
a light modulation device configured to modulate light emitted from the light source device in accordance with image information; and
a projection optical device according to claim 1 configured to project the light modulated by the light modulation device on a projection target surface.

7. A projector comprising:
a light source device configured to emit light;
a light modulation device configured to modulate light emitted from the light source device in accordance with image information; and
a projection optical device according to claim 2 configured to project the light modulated by the light modulation device on a projection target surface.

8. A projector comprising:
a light source device configured to emit light;
a light modulation device configured to modulate light emitted from the light source device in accordance with image information; and
a projection optical device according to claim 3 configured to project the light modulated by the light modulation device on a projection target surface.

9. A projector comprising:
a light source device configured to emit light;
a light modulation device configured to modulate light emitted from the light source device in accordance with image information; and
a projection optical device according to claim 4 configured to project the light modulated by the light modulation device on a projection target surface.

10. A projector comprising:
a light source device configured to emit light;
a light modulation device configured to modulate light emitted from the light source device in accordance with image information; and
a projection optical device according to claim 5 configured to project the light modulated by the light modulation device on a projection target surface.
